(19) United States
(12) Patent Application Publication
(10) Pub. No.: US 2026/0276370 A1
(43) Pub. Date: Sep. 17, 2026

(54) NON-CONTACT SHAPE MEASURING APPARATUS AND POSITION ADJUSTMENT METHOD

(71) Applicant: Tokyo Seimitsu Co., Ltd., Tokyo (JP)

(72) Inventors: Yoshiyuki Kawata, Ibaraki (JP); Toshimitsu Komatsu, Ibaraki (JP)

(21) Appl. No.: 19/676,270

(22) Filed: May 13, 2026

Related U.S. Application Data
(63) Continuation of application No. PCT/JP2024/039071, filed on Nov. 1, 2024.

(30) Foreign Application Priority Data
Nov. 13, 2023 (JP) 2023-193133

(51) Int. Cl. G01B 11/24

(52) U.S. Cl. CPC G01B 11/24

(57) ABSTRACT

A non-contact shape measuring apparatus includes: a sensor head ; an optical sensor in which an incidence position of reflected light on a light-receiving surface changes in accordance with a distance between the sensor head and a measurement surface; a distance measurement unit configured to measure the distance based on the incidence position of the reflected light on the light-receiving surface; and a movement mechanism configured to move one of the sensor head and the measurement surface toward and away from the other along an movement axis. A measurement range is set in advance at a position separated from the sensor head in an emission direction of measurement light. The light-receiving surface has a size sufficient to receive the reflected light even when the one is moved toward the other by the movement mechanism until the one reaches a position at which the measurement surface falls within a proximity range.

### CROSS-REFERENCE TO RELATED APPLICATIONS

The present application is a Continuation of PCT International Application No. PCT/JP2024/039071 filed on November 1, 2024 claiming priority under 35 U.S.C §119(a) to Japanese Patent Application No. 2023-193133 filed on November 13, 2023. Each of the above applications is hereby expressly incorporated by reference, in its entirety, into the present application.

### BACKGROUND OF THE INVENTION

### FIELD OF THE INVENTION

The present invention relates to a non-contact shape measuring apparatus that measures a shape of a measurement surface in a non-contact manner, and a position adjustment method for the non-contact shape measuring apparatus.

### DESCRIPTION OF THE RELATED ART

Surface shape measuring apparatuses are known that measure a shape, including a contour shape and surface roughness, of a measurement surface of a workpiece (an object to be measured). In such a surface shape measuring apparatus, a contact is horizontally moved relative to a workpiece while the contact is in contact with a measurement surface. With this relative movement, a displacement of the contact due to its shakes is detected by a sensor head while the contact traces a measurement surface. A surface shape of the measurement surface is measured based on a displacement detection signal output from the sensor head (see Patent Literature 1).

Non-contact shape measuring apparatuses are well known in these years that execute shape measurement on a measurement surface by horizontally moving a sensor head capable of measuring a distance to the measurement surface in a non-contact manner relative to a workpiece, instead of bringing a contact into contact with the measurement surface (see Patent Literature 2). The sensor head for non-contact measurement measures the distance to the measurement surface using, for example, triangulation. Specifically, measurement light is emitted from the sensor head toward the measurement surface, and reflected light from the measurement surface is received by an optical sensor of the sensor head. Since an incidence position of the reflected light on a light-receiving surface of the optical sensor changes depending on a distance between the sensor head and the measurement surface, the distance between the sensor head and the measurement surface can be measured based on the incidence position of the reflected light on the light-receiving surface.

### Citation List

### Patent Literature(s)

Patent Literature 1: Japanese Patent Application Laid-Open No. 2017-161548

Patent Literature 2: Japanese Patent Application Laid-Open No. 2011-196736

### SUMMARY OF THE INVENTION

FIG. 20 is an explanatory diagram for explaining adjustment of a height position in a Z direction of a sensor head 100 before execution of non-contact measurement on a measurement surface Wa of a workpiece W by a non-contact shape measuring apparatus. Note that, of XY directions and the Z direction perpendicular to one another in FIG. 20, the X and Y directions are directions parallel to a horizontal direction and that the Z direction is a vertical direction perpendicular to the horizontal direction. The X direction is a movement direction (scanning direction) of the sensor head 100 and, the Z direction is an emission direction of measurement light L emitted from a lower side of from the sensor head 100.

As shown in FIG. 20, a measurement range WR where a shape of the measurement surface Wa can be measured when the sensor head 100 is moved in the X direction is located below the sensor head 100 in the Z direction and is separated from the sensor head 100 when viewed in the Y direction. For this reason, as indicated by reference character XXA in FIG. 20, in shape measurement on the measurement surface Wa having a recessed portion 102 thereon, when Z-direction position adjustment on the sensor head 100 is executed such that the measurement surface Wa is located at a central position in the Z direction of the measurement range WR, a lowest point of the recessed portion 102 falls outside the measurement range WR.

To cope with this, as indicated by reference character XXB in FIG. 20, Z-direction position adjustment on the sensor head 100 that involves advancing the sensor head 100 toward the measurement surface Wa and moving the sensor head 100 as close to the measurement surface Wa as possible is executed such that the lowest point of the recessed portion 102 falls within the measurement range WR.

When performing such Z-direction position adjustment of the sensor head 100, it is necessary to avoid collision or contact of the sensor head 100 with the measurement surface Wa, thereby preventing damage to the sensor head 100 and the workpiece W. To this end, a method is known that provides a piezoelectric sensor on a lower surface of the sensor head 100 and lowers the sensor head 100 in the Z direction based on a signal output from the piezoelectric sensor until the sensor head 100 comes into contact with the measurement surface Wa. A method is also known that separately provides a ranging sensor for measuring a distance to the measurement surface Wa at the sensor head 100 and moves the sensor head 100 as close to the measurement surface Wa as possible based on a measurement result from the ranging sensor, instead of providing a piezoelectric sensor on the lower surface of the sensor head 100.

The method involving provision of the piezoelectric sensor on the lower surface of the sensor head 100, however, cannot move the sensor head 100 closer to the measurement surface Wa such that the sensor head 100 is at a distance (working distance) smaller than a thickness of the piezoelectric sensor from the measurement surface Wa. The method also suffers the trouble of routing wiring extending from the piezoelectric sensor. In addition, because the piezoelectric sensor ends up coming into contact with the measurement surface Wa, the possibility of damage to the sensor head 100 and the measurement surface Wa (the workpiece W) cannot be precluded. Further, the piezoelectric sensor has a finite size, and this finite size substantially reduces the working distance. The wiring of the piezoelectric sensor is likely to pick up vibrations, which may lead to measurement noise.

As for the method involving separate provision of the ranging sensor at the sensor head 100, in a case where an inexpensive sensor (e.g., an ultrasonic sensor) is used as the ranging sensor, the ranging sensor has low measurement accuracy, and the sensor head 100 cannot be moved as close to the measurement surface Wa as possible. On the other hand, use of a high-accuracy sensor as the ranging sensor increases manufacturing costs. Since a measurement axis of the sensor head 100 and a measurement axis of the ranging sensor are non-coincident, in a case where the measurement surface Wa has an uneven shape, it is difficult to execute Z-direction position adjustment on the sensor head 100 such that the lowest point of the recessed portion 102 falls within the measurement range WR. Due to the discrepancy between the measurement axis of the ranging sensor and that of the sensor head 100, the method cannot cope with, e.g., a case where the workpiece W is small.

The present invention has been made in view of the above-described circumstances, and has as its object to provide a non-contact shape measuring apparatus capable of inexpensively and accurately moving one of a sensor head and a measurement surface closer to the other, and a position adjustment method used by the non-contact shape measuring apparatus.

A non-contact shape measuring apparatus for achieving the object of the present invention includes a sensor head configured to emit measurement light toward a measurement surface and receive incident reflected light of the measurement light reflected by the measurement surface; an optical sensor having a light-receiving surface that receives the reflected light incident on the sensor head, in which an incidence position of the reflected light on the light-receiving surface changes in accordance with a distance between the sensor head and the measurement surface; a distance measurement unit configured to measure the distance based on the incidence position of the reflected light on the light-receiving surface; and a movement mechanism configured to move one of the sensor head and the measurement surface toward and away from the other of the sensor head and the measurement surface, along an movement axis determined in advance. A measurement range for measuring the distance in the emission direction, is set in advance at a position separated from the sensor head in an emission direction of the measurement light, and the light-receiving surface has a size sufficient to receive the reflected light even in a case where the movement mechanism moves the one toward the other until the one reaches a position at which the measurement surface falls within a proximity range that is a range set between the sensor head and the measurement range.

The non-contact shape measuring apparatus may detect approach of one of the sensor head and the measurement surface to the other by causing a part of the optical sensor to function as a proximity sensor.

In the non-contact shape measuring apparatus according to another aspect of the present invention, the reflected light that is reflected by the measurement surface to a direction different from an incident direction of the measurement light comes incident on the sensor head.

In the non-contact shape measuring apparatus according to another aspect of the present invention, the measurement light emitted from the sensor head and the reflected light incident on the sensor head are coaxial.

The non-contact shape measuring apparatus according to another aspect of the present invention includes a position adjusting unit configured to drive the movement mechanism to move the one toward the other; and a movement amount calculation unit configured to calculate a movement amount required to make the other closest to the one within a range where the measurement surface falls within the measurement range, after the measurement surface reaches the measurement range during approach of the one toward the other, wherein the position adjusting unit drives the movement mechanism to move the one toward the other by the movement amount, after the measurement surface reaches the measurement range during approach of the one to the other, based on a result of reception of the reflected light by the optical sensor. Thus, it is possible to automatically move the sensor head closed to the measurement surface.

In the non-contact shape measuring apparatus according to another aspect of the present invention, the position adjusting unit stops the driving of the movement mechanism in a case where the optical sensor fails to receive the reflected light, after the measurement surface reaches the measurement range. This allows prevention of contact of the sensor head with the measurement surface.

In the non-contact shape measuring apparatus according to another aspect of the present invention, includes an proximity determination unit configured to determine whether the one has moved toward the other until the one reaches a position at which the measurement surface falls within the proximity range, based on a voltage value of a light reception signal of the reflected light output from the optical sensor, wherein the voltage value of the light reception signal varies in accordance with the incidence position of the reflected light on the light-receiving surface.

In the non-contact shape measuring apparatus according to another aspect of the present invention, the movement axis is parallel to a vertical direction.

A position adjustment method for achieving the object of the present invention is a position adjustment method for adjusting a position of the one along the movement axis in the above-described non-contact shape measuring apparatus, the method including: a first approach step of moving, by the movement mechanism, the one toward the other; a first stop step of stopping the first approach step at a position at which the measurement surface falls within the measurement range, based on a result of reception of the reflected light by the optical sensor during execution of the first approach step; a second approach step of moving, by the movement mechanism, the one toward the other after the first stop step; a signal output step of outputting a proximity signal indicating that the one is in a proximity of the other in a case where the one is moved toward the other until the one reaches a position at which the measurement surface falls within the proximity range, based on a result of reception of the reflected light by the optical sensor during execution of the second approach step; a separation step of moving, by the movement mechanism, the one away from the other in a case where the signal output step is executed; and a second stop step of stopping the separation step in a case where the measurement surface reaches the measurement range, based on a result of reception of the reflected light by the optical sensor during execution of the separation step.

The position adjustment method makes it possible to make the sensor head closest to the measurement surface.

In the position adjustment method according to another aspect of the present invention, the one is moved at higher speed in the first approach step than in the second approach step and the separation step. This allows shortening of a time required for position adjustment.

According to the present invention, it is possible to inexpensively and accurately move one of the sensor head and the measurement surface toward the other.

### BRIEF DESCRIPTION OF THE DRAWINGS

FIG. 1 is a schematic view of a surface shape measuring apparatus according to a first embodiment;

FIG. 2 is a schematic view of a sensor head according to the first embodiment;

FIG. 3 is an explanatory view for explaining a measurement range of the sensor head;

FIG. 4 is an explanatory view for explaining a head position range indicating a range of a Z-direction height position of the sensor head that is allowed at the time of shape measurement on a measurement surface;

FIG. 5 is a view showing a state in which the sensor head is moved closer to the measurement surface beyond the head position range shown in FIG. 4;

FIG. 6 is an explanatory view for explaining an optical sensor of the sensor head;

FIG. 7 is a functional block diagram of a control device according to the first embodiment;

FIG. 8 is a flowchart showing the flow of a shape measurement process on a measurement surface of a workpiece by the surface shape measuring apparatus according to the first embodiment;

FIG. 9 is a flowchart showing the flow of a height position adjustment process on the sensor head in FIG. 8;

FIG. 10 is an explanatory view for explaining the height position adjustment process on the sensor head;

FIG. 11 is a functional block diagram of a control device of a surface shape measuring apparatus according to a second embodiment;

FIG. 12 is an explanatory view for explaining a movement amount to be calculated by a movement amount calculation unit;

FIG. 13 is a flowchart showing the flow of a height position adjustment process on a sensor head in the surface shape measuring apparatus according to the second embodiment;

FIG. 14 is an explanatory view for explaining the height position adjustment process on the sensor head in the surface shape measuring apparatus according to the second embodiment;

FIG. 15 is an explanatory view for explaining a reason to stop movement of the sensor head in step S17A of FIG. 13;

FIG. 16 is an explanatory chart for explaining a first light-receiving region and a second light-receiving region on a light-receiving surface of an optical sensor that receives reflected light incident on a sensor head based on a color confocal method;

FIG. 17 is an explanatory chart for explaining, in detail, the second light-receiving region described with reference to FIG. 16;

FIG. 18 is an explanatory chart for explaining a method of proximity determination by a proximity determination unit according to a fourth embodiment;

FIG. 19 is an explanatory view for explaining a modification of the surface shape measuring apparatus according to each of the above-described embodiments; and

FIG. 20 is an explanatory view for explaining Z-direction height position adjustment on a sensor head before execution of non-contact measurement on a measurement surface of a workpiece by a non-contact shape measuring apparatus.

### DESCRIPTION OF THE EMBODIMENTS

### First Embodiment

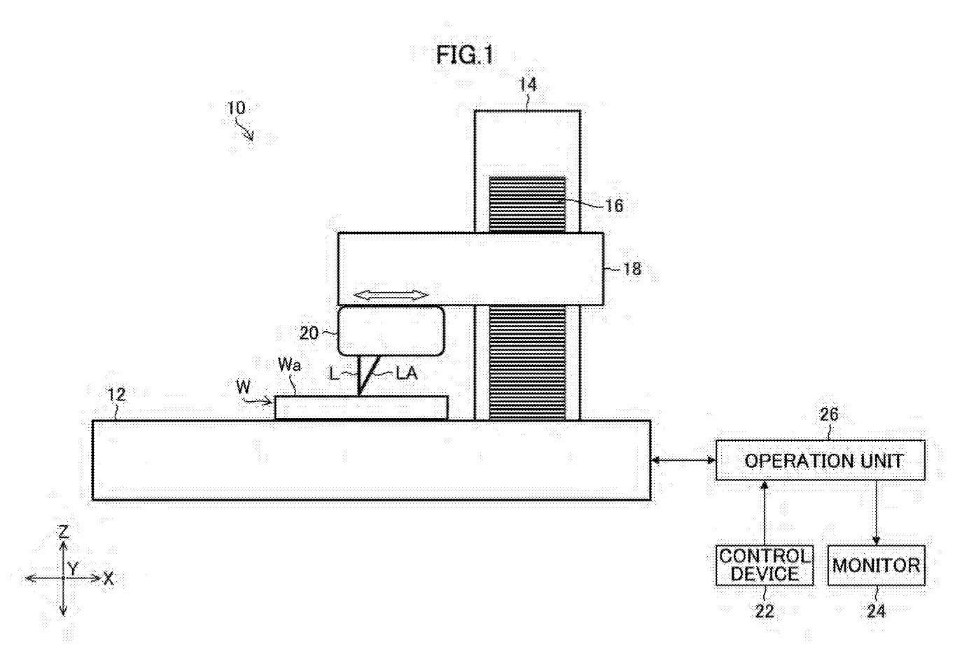

FIG. 1 is a schematic view of a surface shape measuring apparatus 10 according to a first embodiment corresponding to a non-contact shape measuring apparatus according to the present invention. As shown in FIG. 1, the surface shape measuring apparatus 10 measures a shape of a measurement surface Wa of a workpiece W or, more specifically, measures a contour shape, surface roughness, or the like in a non-contact manner. Note that, of X, Y, and Z directions perpendicular to one another in FIG. 1, the X and Y directions are directions parallel to a horizontal direction and that the Z direction is a vertical direction perpendicular to the horizontal direction. The Z direction is a direction parallel (the term "parallel" as used herein is intended to include the meaning of "generally parallel"; the same applies hereinafter) to a movement axis according to the present invention.

The surface shape measuring apparatus 10 includes a measurement table 12, a C-axis unit 14, a C-axis movement mechanism 16, a holder 18, a sensor head 20, an operation unit 22, a monitor 24, and a control device 26.

The measurement table 12 has the shape of a generally (substantially) flat plate and has an upper surface parallel to an XY plane. On the upper surface of the measurement table 12, the workpiece W is set, and the C-axis unit 14 is provided.

The C-axis unit 14 corresponds to the movement axis according to the present invention and is a column extending (upward) in the Z direction from the upper surface of the measurement table 12. The holder 18 is attached to the C-axis unit 14 via the C-axis movement mechanism 16 such that the holder 18 is movable in the Z direction.

The C-axis movement mechanism 16 moves the holder 18 along the C-axis unit 14, i.e., in the Z direction, thereby executing Z-direction position adjustment (height position adjustment) for the sensor head 20. This allows adjustment of a distance between the sensor head 20 and the measurement surface Wa. Note that, in this case, the sensor head 20 corresponds to "one" according to the present invention while the measurement surface Wa corresponds to "the other" according to the present invention.

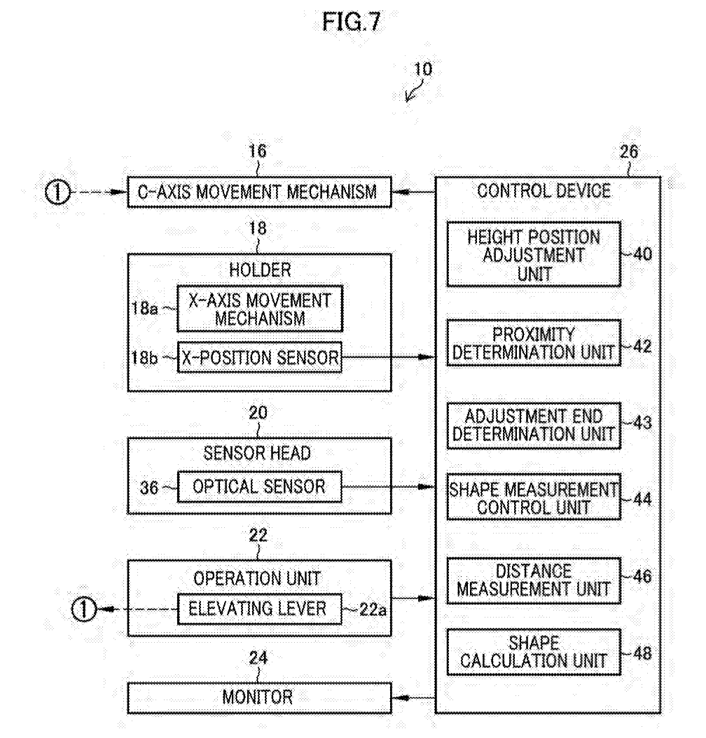

The C-axis movement mechanism 16 is a publicly known actuator that moves the holder 18 along the C-axis unit 14 (the Z direction). The C-axis movement mechanism 16 causes the holder 18 to move automatically in the Z direction under control by the control device 26 (to be described later) or causes the holder 18 to move in the Z direction in response to an operation (manual movement operation) of an elevating lever 22a (see FIG. 7) by an operator. Note that the manual movement operation of the holder 18 may be performed using a publicly known operation member other than the elevating lever 22a.

As shown in FIG. 7 (to be described later), the holder 18 includes an X-axis movement mechanism 18a and an X-position sensor 18b. The X-axis movement mechanism 18a is a publicly known actuator that holds the sensor head 20 such that the sensor head 20 is movable in the X direction under control by the control device 26 (to be described later). Driving of the X-axis movement mechanism 18a allows movement of the sensor head 20 relative to the workpiece W (the measurement surface Wa) in the X direction. Although not shown, the X-position sensor 18b includes a linear scale, a read head therefor, and the like. The X-position sensor 18b detects an X-direction position of the sensor head 20 and outputs a detection result to the control device 26. Note that the X-axis movement mechanism 18a and the X-position sensor 18b are not limited to the above-described configurations and that, for example, a stepping motor may be used as a driving source for the X-axis movement mechanism 18a. In this case, the X-position sensor 18b is capable of position detection based on the number of driving pulses of the stepping motor.

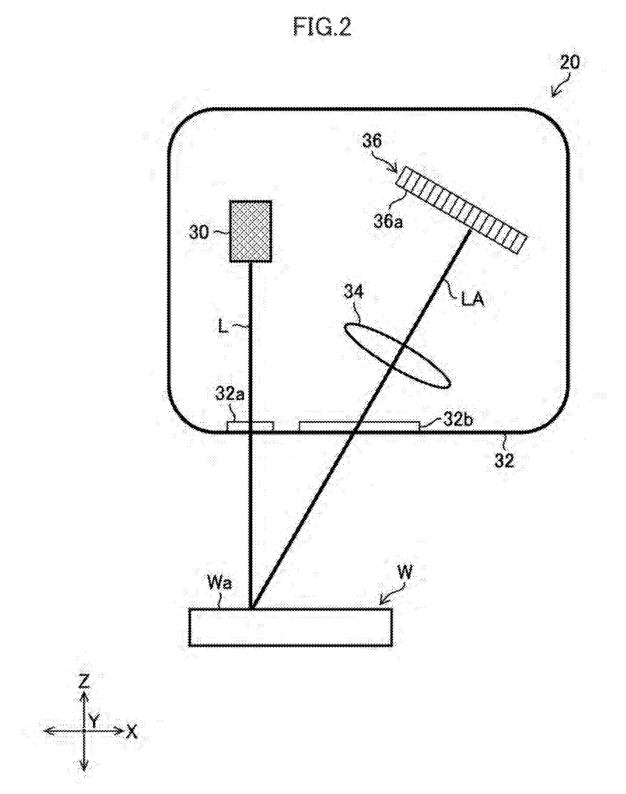

The sensor head 20 is a detector (ranging sensor) used for measurement (non-contact distance measurement) of a distance to the measurement surface Wa based on a triangulation method. The sensor head 20 emits measurement light L toward the measurement surface Wa located below the sensor head 20 in the Z direction and receives reflected light LA of the measurement light L reflected by the measurement surface Wa. Thus, in the present embodiment, a downward direction in the Z direction is an emission direction of the measurement light L for the sensor head 20. A configuration of the sensor head 20 will be described later (see FIG. 2). With movement of the sensor head 20 in the X direction by the X-axis movement mechanism 18a (see FIG. 7), the measurement surface Wa can be scanned along the X direction with the measurement light L.

As the operation unit 22, for example, a keyboard, a mouse, an operation panel, operation buttons, and the like are used, and the operation unit 22 accepts input of various operations by the operator. The operation unit 22 also includes the elevating lever 22a (see FIG. 7) for the operator to manually operate the C-axis movement mechanism 16.

As the monitor 24, arbitrary type of display, such as a publicly known LCD, is used. The monitor 24 displays a result of shape measurement on the measurement surface Wa by the surface shape measuring apparatus 10, various types of settings screens of the surface shape measuring apparatus 10, various types of operation screens of the surface shape measuring apparatus 10, and the like.

The control device 26 has a connection to the C-axis movement mechanism 16, the holder 18, the sensor head 20, the operation unit 22, and the monitor 24. The control device 26 controls, in an integrated manner, actions of the units of the surface shape measuring apparatus 10 in response to an input operation to the operation unit 22.

FIG. 2 is a schematic view of the sensor head 20 according to the first embodiment. As shown in FIG. 2, the sensor head 20 includes a light source 30, a light entrance/exit surface 32, a lens 34, and an optical sensor 36. The light source 30 emits the measurement light L downward in the Z direction.

The light entrance/exit surface 32 is a bottom surface on a lower side in the Z direction that faces the measurement surface Wa and has a light exit window 32a and a light entrance window 32b. The light exit window 32a is formed at a position below the light source 30 in the Z direction of the light entrance/exit surface 32, and allows the measurement light L emitted from the light source 30 to pass through and lets the measurement light L go out toward the measurement surface Wa. The light entrance window 32b is formed at a position shifted in the X direction from the light exit window 32a of the light entrance/exit surface 32. The reflected light LA reflected by the measurement surface Wa to a direction different from an incident direction of the measurement light L comes incident on the light entrance window 32b.

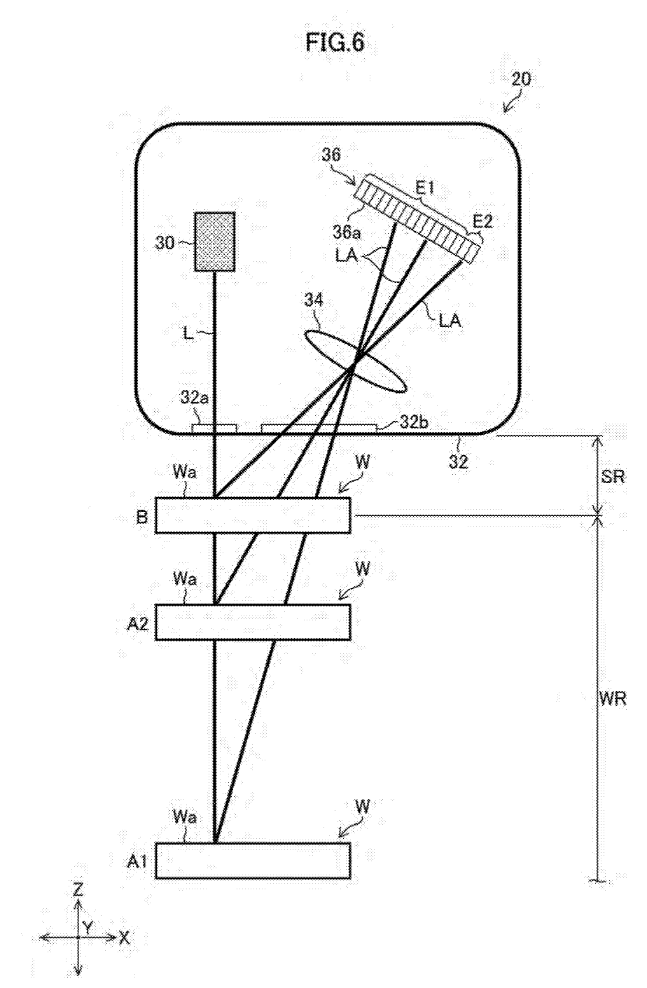

Note that the light entrance window 32b is formed to be larger in X-direction width than the light exit window 32a so as to respond to changes in an incidence position and an incidence angle of the reflected light LA on the light entrance/exit surface 32 in accordance with the distance between the sensor head 20 and the measurement surface Wa (see FIG. 6). The light exit window 32a and the light entrance window 32b may be openings.

The lens 34 transmits the reflected light LA incident from the light entrance window 32b and lets the reflected light LA go out toward a light-receiving surface 36a of the optical sensor 36.

The optical sensor 36 is, for example, a CCD (Charge Coupled Device) type or CMOS (Complementary Metal-Oxide-Semiconductor) type one-dimensional or two-dimensional imaging device, and has the light-receiving surface 36a that receives the reflected light LA incident from the measurement surface Wa via the light entrance window 32b and the lens 34. In the sensor head 20 based on the triangulation method, an incidence position of the reflected light LA on the light-receiving surface 36a changes in accordance with a distance between the sensor head 20 and the measurement surface Wa in the emission direction (the Z direction here) of the measurement light L. It is thus possible to measure the distance between the sensor head 20 and the measurement surface Wa based on the incidence position of the reflected light LA on the light-receiving surface 36a.

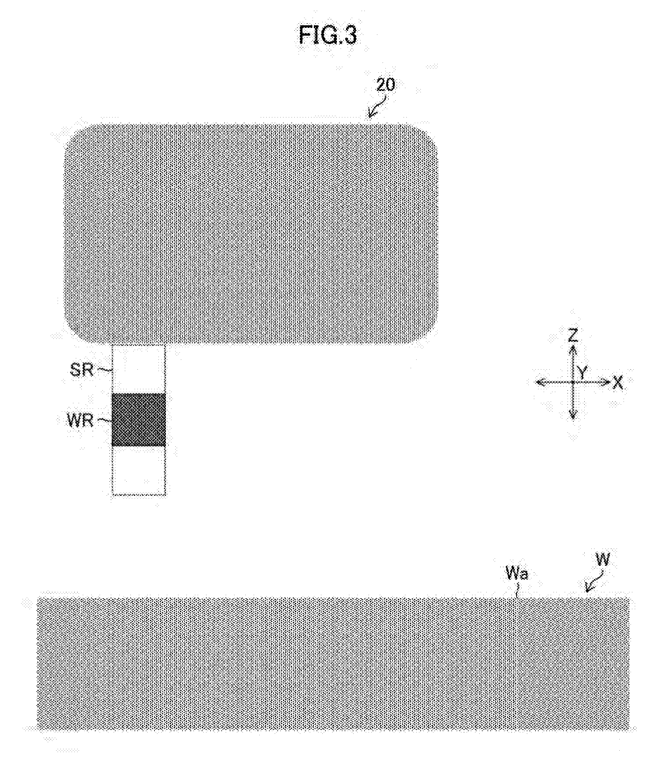

FIG. 3 is an explanatory view for explaining a measurement range WR of the sensor head 20. In the sensor head 20 based on the triangulation method, the incidence position of the reflected light LA on the light-receiving surface 36a changes in accordance with the distance between the sensor head 20 and the measurement surface Wa, as described earlier. For this reason, the Z-direction measurement range WR (hereinafter simply referred to as the measurement range WR), where a distance to the measurement surface Wa may be measured with high accuracy, is determined in advance in accordance with the size of the light-receiving surface 36a for each type of sensor head 20. The measurement range WR is set at a position below the sensor head 20 in the Z direction separated from the sensor head 20. A proximity range SR is set between the sensor head 20 (the light entrance/exit surface 32) and the measurement range WR, and the proximity range SR is a range nearer to the sensor head 20 than the measurement range WR is.

Note that although a lens (not shown) is generally inserted between the light source 30 and the light exit window 32a in the sensor head 20 to reduce a spot diameter of the measurement light L, the spot diameter is larger on a side nearer to the sensor head 20, in a case where a lens with a short focal distance is used to increase a lateral resolution of the sensor head 20. For this reason, a range less suitable for measurement requiring the sensor head 20 to have a high lateral resolution may be assigned as the proximity range SR.

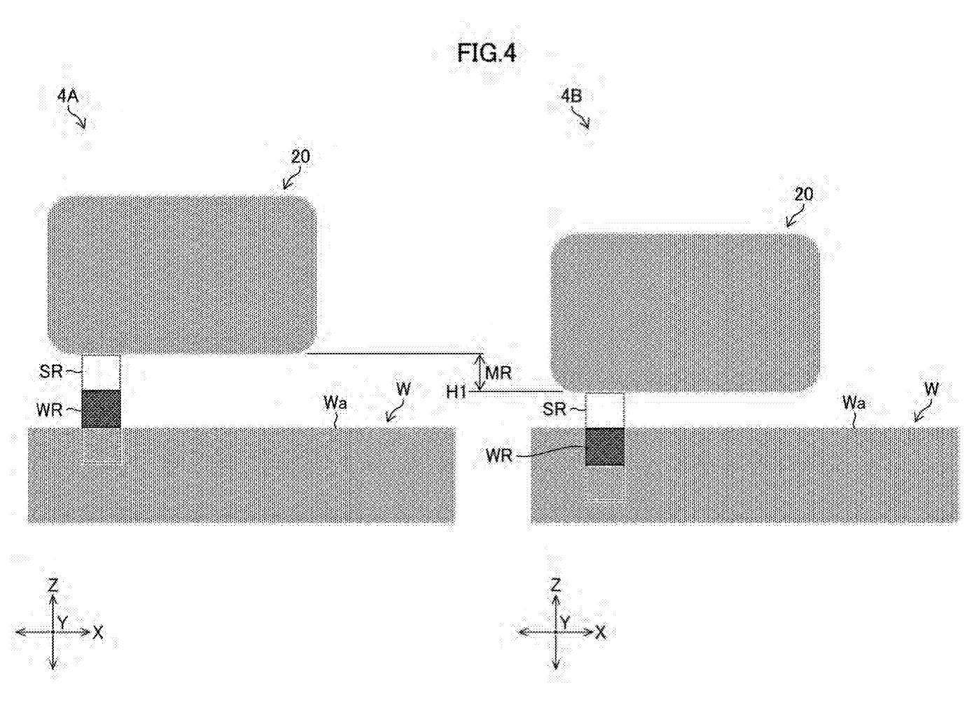

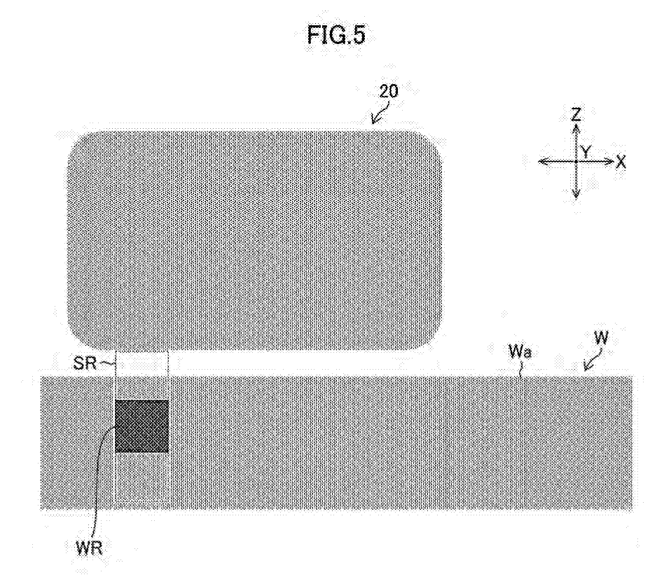

FIG. 4 is an explanatory view for explaining a head position range MR that indicates an allowable range of a Z-direction height position of the sensor head 20 when performing shape measurement on the measurement surface Wa. FIG. 5 is a view showing a state in which the sensor head 20 is moved closer to the measurement surface Wa beyond the head position range MR shown in FIG. 4.

As indicated by reference characters 4A and 4B in FIG. 4, the C-axis movement mechanism 16 executes Z-direction height position adjustment for the sensor head 20 such that the measurement surface Wa falls within the measurement range WR of the sensor head 20, i.e., between a lower end (see reference character 4A in FIG. 4) and an upper end (see reference character 4B in FIG. 4) of the measurement range WR in the Z direction, at the time of shape measurement on the measurement surface Wa. Specifically, the C-axis movement mechanism 16 adjusts the Z-direction height position of the sensor head 20 (the light entrance/exit surface 32 here) to within the head position range MR that is a position range where the measurement surface Wa falls within the measurement range WR.

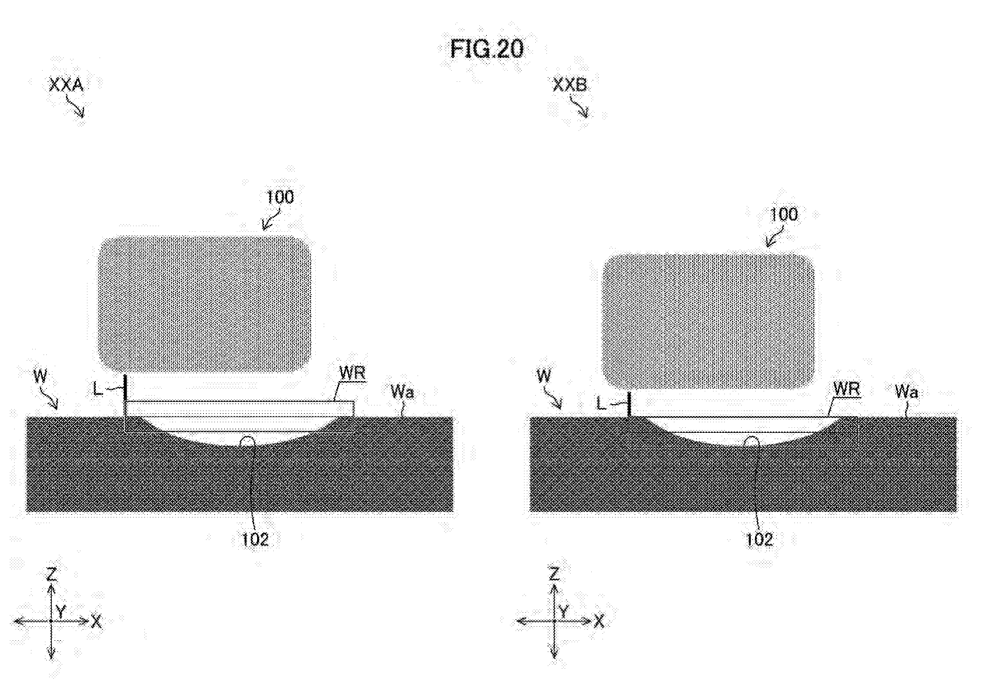

As shown in FIG. 20 described earlier, the measurement surface Wa may have a recessed portion 102 formed therein. For this reason, in shape measurement on the measurement surface Wa, the sensor head 20 is preferably moved as close to the measurement surface Wa as possible until the sensor head 20 reaches a height position (hereinafter referred to as a target height position H1) at which the upper end of the measurement range WR reaches the measurement surface Wa as viewed from the Y direction, as indicated by reference character 4B in FIG. 4.

In the present embodiment, in order to move the sensor head 20 as close to the measurement surface Wa as possible, the sensor head 20 is temporarily moved closer to the measurement surface Wa until the sensor head 20 reaches a position at which the measurement surface Wa falls within the proximity range SR, as shown in FIG. 5. The sensor head 20 is then moved upward in the Z direction and is away (separate) from the measurement surface Wa, thereby positionally adjusting the sensor head 20 to the target height position H1 indicated by reference character 4B in FIG. 4.

In moving the sensor head 20 closer to the measurement surface Wa until the sensor head 20 reaches a position at which the measurement surface Wa falls within the proximity range SR, it is necessary to enable detection of the measurement surface Wa within the proximity range SR in order to avoid contact of the sensor head 20 with the measurement surface Wa. A piezoelectric sensor or a ranging sensor is provided to the sensor head 20 to enable the detection suffers accuracy and cost problems.

Under the circumstances, in the present embodiment, the size of the optical sensor 36 (the light-receiving surface 36a) of the sensor head 20 is adjusted (is made larger than existing ones), thereby enabling detection of the measurement surface Wa within the proximity range SR (see FIG. 6).

FIG. 6 is an explanatory view for explaining the optical sensor 36 of the sensor head 20. Note that reference characters A1 and A2 in FIG. 6 each denote the measurement surface Wa located within the measurement range WR while reference character B in FIG. 6 denotes the measurement surface Wa located within the proximity range SR.

As shown in FIG. 6, the light-receiving surface 36a of the optical sensor 36 has a size enough to receive the reflected light LA reflected by the measurement surface Wa (see reference character B) within the proximity range SR in addition to the reflected light LA reflected by the measurement surfaces Wa (see reference characters A1 and A2) within the measurement range WR. For this reason, a first light-receiving region E1 which receives the reflected light LA from the measurement surface Wa within the measurement range WR and a second light-receiving region E2 which receives the reflected light LA from the measurement surface Wa within the proximity range SR are included in the light-receiving surface 36a. The second light-receiving region E2 functions as a proximity sensor capable of detecting the measurement surface Wa within the proximity range SR.

As described above, in the sensor head 20, a part of the optical sensor 36 (the light-receiving surface 36a) is assigned for a proximity sensor. This enables detection that the sensor head 20 is moved close enough to the measurement surface Wa that the sensor head 20 reaches a position at which the measurement surface Wa falls within the proximity range SR, without provision of a piezoelectric sensor, a ranging sensor, or the like,.

FIG. 7 is a functional block diagram of the control device 26 according to the first embodiment. As shown in FIG. 7, the control device 26 includes a computing circuit having, e.g., various types of processors and memories. The various types of processors include a CPU (Central Processing Unit), a GPU (Graphics Processing Unit), an ASIC (Application Specific Integrated Circuit), and programmable logic devices (e.g., an SPLD (Simple Programmable Logic Device), a CPLD (Complex Programmable Logic Device), and an FPGA (Field Programmable Gate Arrays). Note that various types of functions of the control device 26 may be implemented by one processor or by a plurality of processors of the same type or different types.

The control device 26 functions as a height position adjusting unit 40, a proximity determination unit 42, an adjustment end determination unit 43, a shape measurement control unit 44, a distance measurement unit 46, and a shape calculation unit 48 by executing a control program read out from a storage unit (not shown).

The height position adjusting unit 40 operates before the start of shape measurement on the measurement surface Wa and executes part of a height position adjustment process of adjusting the Z-direction height position of the sensor head 20 to the target height position H1 (see reference character 4B in FIG. 4).

The height position adjustment process on the sensor head 20 is roughly divided into a first position adjustment process, a second position adjustment process, and a third position adjustment process. The first position adjustment process is a process of moving the sensor head 20 downward in the Z direction from an initial position located above the measurement surface Wa in the Z direction and separated from the measurement surface Wa to a position at which the measurement surface Wa falls within the measurement range WR. The second position adjustment process is a process of further moving the sensor head 20 downward in the Z direction to a position at which the measurement surface Wa falls within the proximity range SR. The third position adjustment process is a process of moving the sensor head 20 upward in the Z direction to the target height position H1. The height position adjusting unit 40 according to the first embodiment drives the C-axis movement mechanism 16 to execute only the first position adjustment process. Note that the second position adjustment process and the third position adjustment process are executed by the operator operating the elevating lever 22a to drive the C-axis movement mechanism 16, i.e., by a manual movement operation.

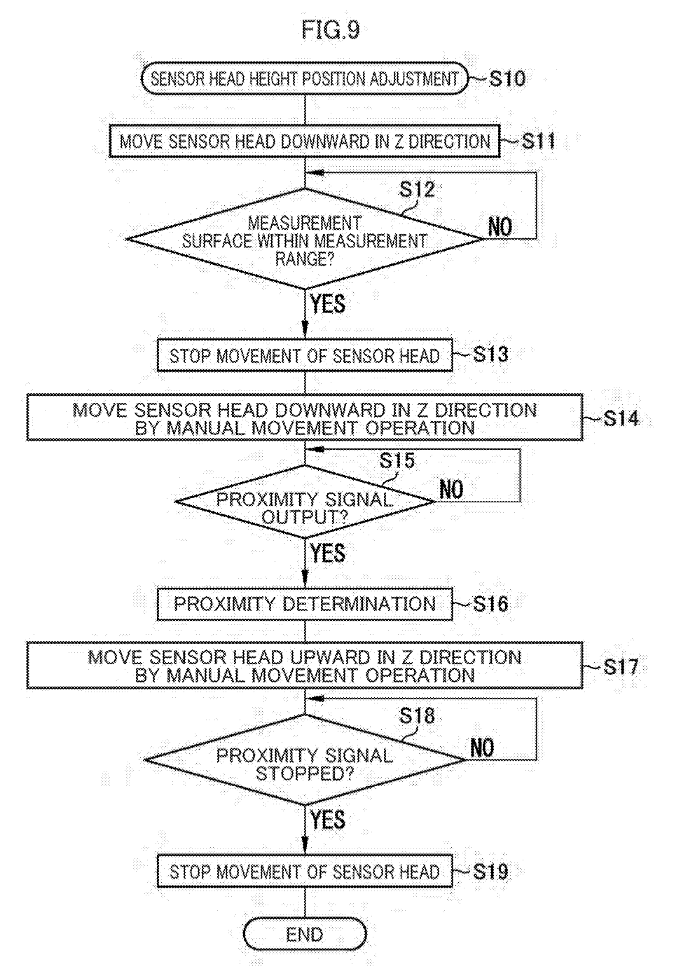

The height position adjusting unit 40 operates to execute the first position adjustment process when a starting operation height position adjustment on the sensor head 20 is executed at the operation unit 22. The height position adjusting unit 40 drives the C-axis movement mechanism 16 to move the sensor head 20 downward in the Z direction along the C-axis unit 14. The height position adjusting unit 40 stops the movement of the sensor head 20 by the C-axis movement mechanism 16 based on a reception result (reception position) of the reflected light LA in the first light-receiving region E1 of the light-receiving surface 36a of the optical sensor 36, in a case where the sensor head 20 reaches a position at which the measurement surface Wa falls within the measurement range WR, such as a case where a central position in the Z direction of the measurement range WR reaches the measurement surface Wa. With this stoppage, the first position adjustment process is completed. After that, the second position adjustment process and the third position adjustment process are executed through manual movement operations by the operator (see FIG. 9).

Note that movement of the sensor head 20 in the first position adjustment process is executed at higher speed than movement of the sensor head 20 in the second position adjustment process and the third position adjustment process that are executed by a manual movement operation.

The proximity determination unit 42 is connected to the sensor head 20 (the optical sensor 36) by, for example, a publicly known communication line (e.g., Ethernet or RS232C). The proximity determination unit 42 operates when the second position adjustment process is started through a manual movement operation by the operator and determines, during execution of the second position adjustment process, whether the sensor head 20 has moved close enough to the measurement surface Wa that the sensor head 20 reaches a position at which the measurement surface Wa falls within the proximity range SR.

Specifically, when the sensor head 20 is moved close enough to the measurement surface Wa that the sensor head 20 reaches a position at which the measurement surface Wa falls within the proximity range SR, the reflected light LA comes incident on the second light-receiving region E2 of the light-receiving surface 36a. A light reception signal of the reflected light LA is output from the second light-receiving region E2. Thus, a light reception signal of the reflected light LA output from the second light-receiving region E2 is a proximity signal indicating that the sensor head 20 is moved close (in a proximity) enough to the measurement surface Wa that the sensor head 20 reaches a position at which the measurement surface Wa falls within the proximity range SR. Therefore, the proximity determination unit 42 can perform proximity determination (hereinafter abbreviated as proximity determination) that determines, based on whether a proximity signal is output from the optical sensor 36, whether the sensor head 20 is in a "proximity state" meaning that the sensor head 20 has moved close enough to the measurement surface Wa that the sensor head 20 reaches a position at which the measurement surface Wa falls within the proximity range SR.

The proximity determination unit 42 causes the monitor 24 to display proximity information to that effect in a case where the proximity determination unit 42 determines, by proximity determination, that the sensor head 20 is in the "proximity state". This allows the operator to know that the sensor head 20 has moved to the measurement surface Wa, i.e., the second position adjustment process is completed.

The adjustment end determination unit 43 operates when the third position adjustment process is started through a manual movement operation by the operator and determines, during execution of the third position adjustment process, whether the sensor head 20 has reached the target height position H1. When the measurement surface Wa reaches from the proximity range SR to the upper end of the measurement range WR in the third position adjustment process, the reflected light LA comes incident on the first light-receiving region E1 of the light-receiving surface 36a. In this case, outputting of a proximity signal from the optical sensor 36 is stopped, and a light reception signal of the reflected light LA is output from the first light-receiving region E1. Thus, the adjustment end determination unit 43 is capable of adjustment end determination (hereinafter abbreviated as adjustment end determination) that determines, based on whether outputting of a proximity signal from the optical sensor 36 is stopped (a light reception signal of the reflected light LA is output from the first light-receiving region E1), whether the sensor head 20 has reached the target height position H1.

The adjustment end determination unit 43 causes the monitor 24 to display adjustment completion information to that effect in a case where the adjustment end determination unit 43 determines, by adjustment end determination, that the sensor head 20 has reached the target height position H1. This allows the operator to know that the sensor head 20 has reached the target height position H1, i.e., height position adjustment on the sensor head 20 is entirely completed.

The shape measurement control unit 44 operates when a starting operation shape measurement on the measurement surface Wa is executed at the operation unit 22 after the position adjustment on the sensor head 20 to the target height position H1. The shape measurement control unit 44 drives the X-axis movement mechanism 18a of the holder 18 to move the sensor head 20 in the X direction, and causes the X-position sensor 18b to start detection of the X-direction position of the sensor head 20. The measurement surface Wa is scanned along the X direction with the measurement light L emitted from the sensor head 20, thereby executing shape measurement on the measurement surface Wa.

When the shape measurement on the measurement surface Wa is started, the distance measurement unit 46 continuously executes measurement of a distance from the sensor head 20 to the measurement surface Wa (a position of irradiation with the measurement light L) based on a position of reception of the reflected light LA incident on the first light-receiving region E1 of the light-receiving surface 36a to continuously output a measurement result of the distance measurement to the shape calculation unit 48. Note that the distance measurement by the distance measurement unit 46 is executed in synchronism with detection of the X-direction position of the sensor head 20 by the X-position sensor 18b.

The shape calculation unit 48 calculates arbitrary type of shape of the measurement surface Wa by a publicly known method based on results of the distance measurement by the distance measurement unit 46 and the X-direction position detection on the sensor head 20 by the X-position sensor 18b that are executed in synchronism with each other.

Note that when the shape measurement on the measurement surface Wa is completed, the operator operates the elevating lever 22a to drive the C-axis movement mechanism 16 and moves (retracts) the sensor head 20 upward in the Z direction along the C-axis unit 14, thereby moving the sensor head 20 away (separate) from the measurement surface Wa. The movement continues until the reflected light LA fails to be received in the first light-receiving region E1 of the light-receiving surface 36a, i.e., until the measurement surface Wa falls outside the measurement range WR. Note that the movement of the sensor head 20 at this time may be executed at higher speed than movement of the sensor head 20 in the second position adjustment process and the third position adjustment process.

### Operation of First Embodiment

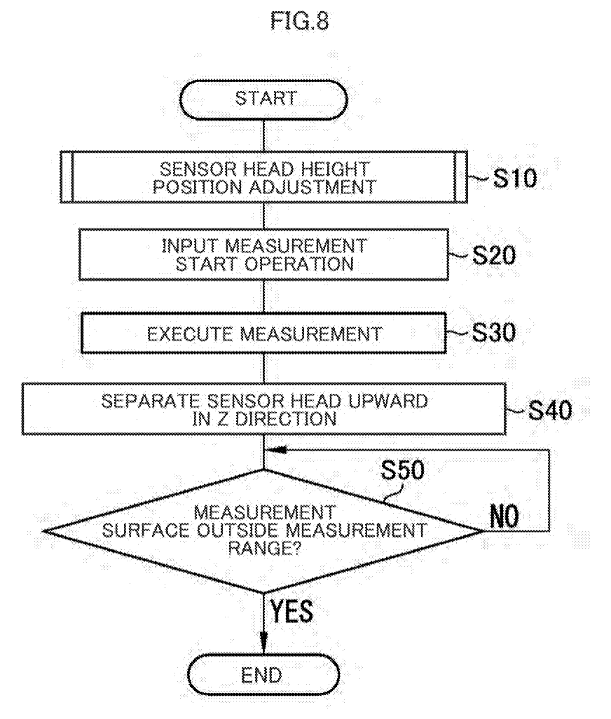

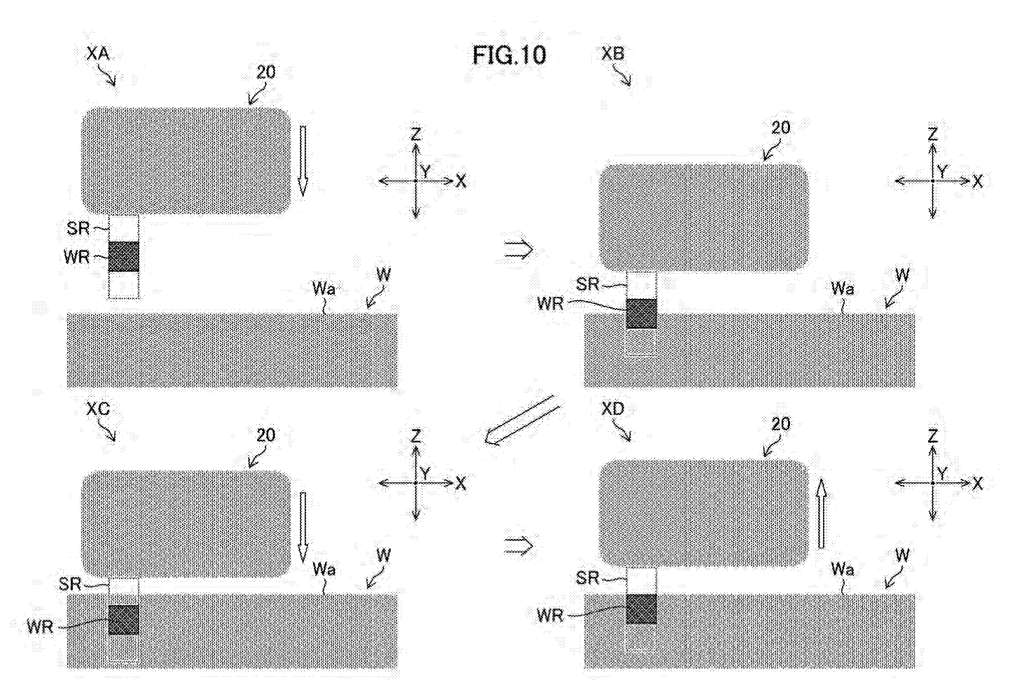

FIG. 8 is a flowchart showing the flow of a shape measurement process on the measurement surface Wa of the workpiece W by the surface shape measuring apparatus 10 according to the first embodiment with the above-described configuration. FIG. 9 is a flowchart showing the flow of the height position adjustment process on the sensor head 20 in FIG. 8, according to a position adjustment method of the present invention. FIG. 10 is an explanatory view for explaining the height position adjustment process on the sensor head 20.

As shown in FIG. 8, after the operator sets the workpiece W on the upper surface of the measurement table 12, the height position adjustment process of adjusting the Z-direction height position of the sensor head 20 to the target height position H1 is first executed (step S10).

As shown in FIGS. 9 and 10, in response to a starting operation height position adjustment at the operation unit 22 by the operator, the height position adjusting unit 40 drives the C-axis movement mechanism 16 to move the sensor head 20 downward in the Z direction along the C-axis unit 14 at high speed (step S11, see reference character XA in FIG. 10). With this movement, the sensor head 20 moves close to (approaches) the measurement surface Wa at high speed. Note that step S11 corresponds to a first approach step according to the present invention.

In a case where the reflected light LA is not received in the first light-receiving region E1 of the light-receiving surface 36a, i.e., a case where the sensor head 20 has not moved close enough to the measurement surface Wa that the sensor head 20 reaches a position at which the measurement surface Wa falls within the measurement range WR, the height position adjusting unit 40 continues moving the sensor head 20 downward in the Z direction at high speed (NO in step S12).

When the sensor head 20 moves close enough to the measurement surface Wa that the sensor head 20 reaches a position at which the measurement surface Wa falls within the measurement range WR, the reflected light LA is received in the first light-receiving region E1 (YES in step S12). When the reflected light LA is received in the first light-receiving region E1, the height position adjusting unit 40 stops the movement of the sensor head 20 by the C-axis movement mechanism 16 at a position at which an arbitrary position (e.g., a central position in the Z direction) within the measurement range WR reaches the measurement surface Wa, based on a result of the light reception (step S13, see reference character XB in FIG. 10). Note that step S13 corresponds to a first stop step according to the present invention. With the above-described processes, the first position adjustment process on the sensor head 20 is completed.

When the first position adjustment process on the sensor head 20 is completed, the operator operates the elevating lever 22a to drive the C-axis movement mechanism 16. The operator moves the sensor head 20 further downward in the Z direction along the C-axis unit 14 at low speed by a manual movement operation (step S14). Note that step S14 corresponds to a second approach step according to the present invention. With this step, the second position adjustment process on the sensor head 20 is started, and the sensor head 20 further approaches the measurement surface Wa. Simultaneously, the proximity determination unit 42 monitors for a proximity signal output from the optical sensor 36, thereby starting proximity determination (NO in step S15).

When the sensor head 20 is moved close enough to the measurement surface Wa that the sensor head 20 reaches a position at which the measurement surface Wa falls within the proximity range SR, the reflected light LA comes incident on the second light-receiving region E2 to output a proximity signal from the optical sensor 36 (YES in step S15, corresponding to a signal output step according to the present invention). With this output, the proximity determination unit 42 determines, by the proximity determination, that the sensor head 20 is in the "proximity state" and causes the monitor 24 to display proximity information to that effect (step S16).

In response to the display of the proximity information on the monitor 24, the operator stops the driving of the C-axis movement mechanism 16 using the elevating lever 22a, thereby stopping the movement of the sensor head 20. The sensor head 20 stops at a height position at which the measurement surface Wa falls within the proximity range SR (see reference character XC in FIG. 10). With the above-described processes, the second position adjustment process on the sensor head 20 is completed.

When the second position adjustment process on the sensor head 20 is completed, the operator operates the elevating lever 22a to drive the C-axis movement mechanism 16. The operator moves the sensor head 20 upward in the Z direction along the C-axis unit 14 by a manual movement operation (step S17). With this movement, the third position adjustment process on the sensor head 20 is started, and the sensor head 20 separates (moves away) from the measurement surface Wa (corresponding to a separation step according to the present invention). Simultaneously, the proximity determination unit 42 monitors for a proximity signal output from the optical sensor 36, thereby starting adjustment end determination (NO in step S18).

When the measurement surface Wa arrives at the upper end of the measurement range WR (within the measurement range WR), the reflected light LA comes incident on the first light-receiving region E1 to stop outputting of a proximity signal from the optical sensor 36 (YES in step S18). With this stop, the adjustment end determination unit 43 determines, by the adjustment end determination, that "the sensor head 20 has reached the target height position H1" and causes the monitor 24 to display adjustment completion information. In response to the display of the adjustment completion information on the monitor 24, the operator stops the driving of the C-axis movement mechanism 16 using the elevating lever 22a, thereby stopping the movement of the sensor head 20 (step S19, corresponding to a second stop step according to the present invention). With this stop, the sensor head 20 is positionally adjusted to the target height position H1 (see reference character XD in FIG. 10). With the above-described processes, the third position adjustment process on the sensor head 20 is completed, i.e., the whole height position adjustment process on the sensor head 20 is completed.

Referring back to FIG. 8, after the position adjustment on the sensor head 20 to the target height position H1, the operator executes a starting operation shape measurement on the measurement surface Wa at the operation unit 22 (step S20). In response to the start operation, the shape measurement control unit 44 drives the X-axis movement mechanism 18a to move the sensor head 20 in the X direction and causes the X-position sensor 18b to start detection of the X-direction position of the sensor head 20, thereby starting the shape measurement on the measurement surface Wa (step S30).

When the shape measurement on the measurement surface Wa is started, distance measurement by the distance measurement unit 46 and detection of the X-direction position of the sensor head 20 by the X-position sensor 18b are continuously executed in synchronism. Based on results of the distance measurement and the detection, the shape calculation unit 48 calculates arbitrary type of shape of the measurement surface Wa by a publicly known method.

When the shape measurement on the measurement surface Wa is completed, the operator operates the elevating lever 22a to drive the C-axis movement mechanism 16. The operator moves the sensor head 20 upward in the Z direction along the C-axis unit 14 at high speed by a manual movement operation. With this movement, the sensor head 20 separates from the measurement surface Wa at high speed (step S40 and NO in step S50). The separation of the sensor head 20 from the measurement surface Wa continues until the measurement surface Wa falls outside the measurement range WR (YES in step S50).

As has been described above, in the surface shape measuring apparatus 10 according to the first embodiment, the size of the light-receiving surface 36a of the optical sensor 36 is made larger than a conventional art, and the optical sensor 36 also functions as a proximity sensor. This allows detection of the measurement surface Wa within the proximity range SR without separate provision of a piezoelectric sensor and a ranging sensor at the sensor head 20. As a result, the sensor head 20 may be inexpensively and accurately moved close to the measurement surface Wa. It is thus possible to inexpensively and accurately perform position adjustment on the sensor head 20 to the target height position H1.

### Second Embodiment

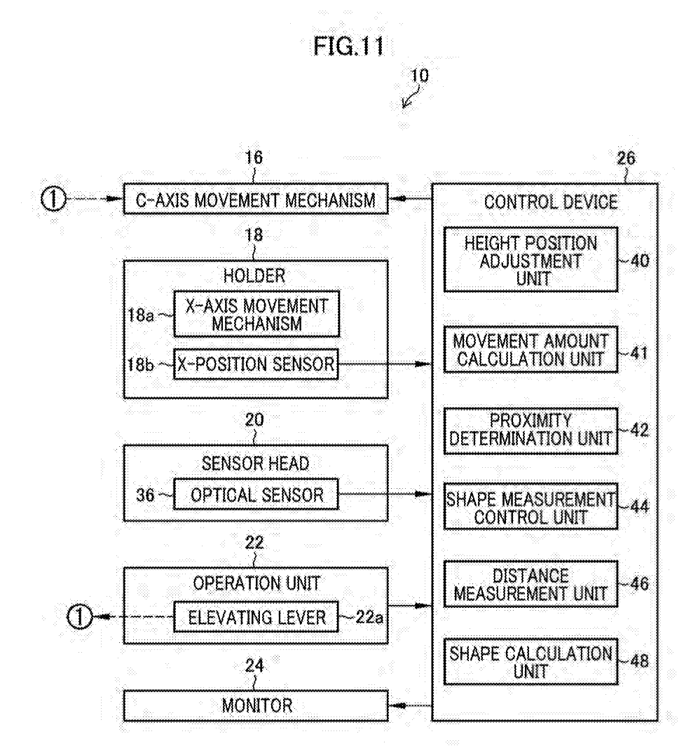

FIG. 11 is a functional block diagram of a control device 26 of a surface shape measuring apparatus 10 according to a second embodiment. In the surface shape measuring apparatus 10 according to the above-described first embodiment, part (the second position adjustment process and the third position adjustment process) of the height position adjustment process on the sensor head 20 is executed through a manual movement operation by an operator. The surface shape measuring apparatus 10 according to the second embodiment automatically executes the whole of a height position adjustment process on a sensor head 20.

As shown in FIG. 11, the surface shape measuring apparatus 10 according to the second embodiment has basically the same configuration as the surface shape measuring apparatus 10 according to the first embodiment except that a function of a height position adjusting unit 40 in the control device 26 is different from that in the first embodiment and that the control device 26 functions as a movement amount calculation unit 41 instead of an adjustment end determination unit 43. For this reason, components functionally or structurally identical to those in the first embodiment are denoted by identical reference numerals, and a description thereof will be omitted.

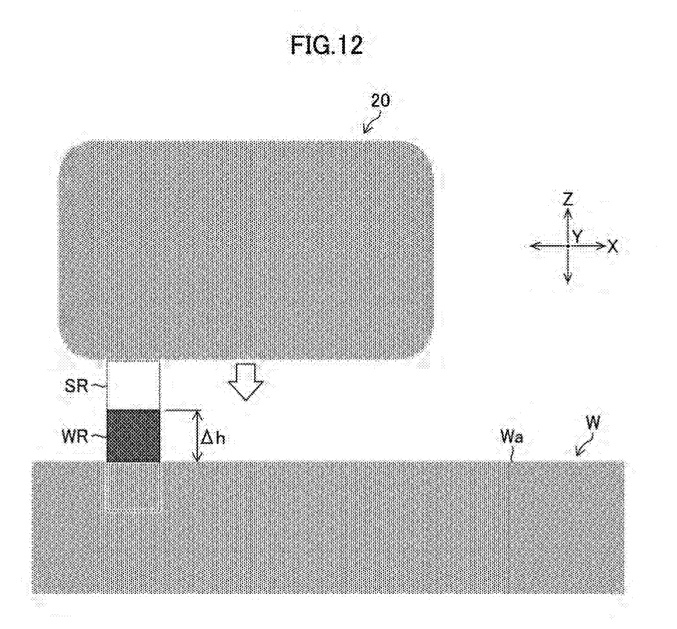

FIG. 12 is an explanatory view for explaining a movement amount Δh to be calculated by the movement amount calculation unit 41. As shown in FIG. 12, the movement amount calculation unit 41 calculates the movement amount Δh needed to move the sensor head 20 as close as possible to the measurement surface Wa within a range where the measurement surface Wa falls within a measurement range WR, after the measurement surface Wa reaches a lower end of the measurement range WR during approach of the sensor head 20 from an initial position described earlier to the measurement surface Wa. The expression "move the sensor head 20 as close as possible to a measurement surface Wa within a range where the measurement surface Wa falls within a measurement range WR" here refers to moving the sensor head 20 to a target height position H1 (see FIG. 4). Since a Z-direction distance from the sensor head 20 to the measurement range WR and a Z-direction width of the measurement range WR are known, the movement amount calculation unit 41 may calculate the movement amount Δh based on the known pieces of information.

Note that, instead of causing the control device 26 to function as the movement amount calculation unit 41, the movement amount Δh calculated in advance may be stored in a storage unit (not shown).

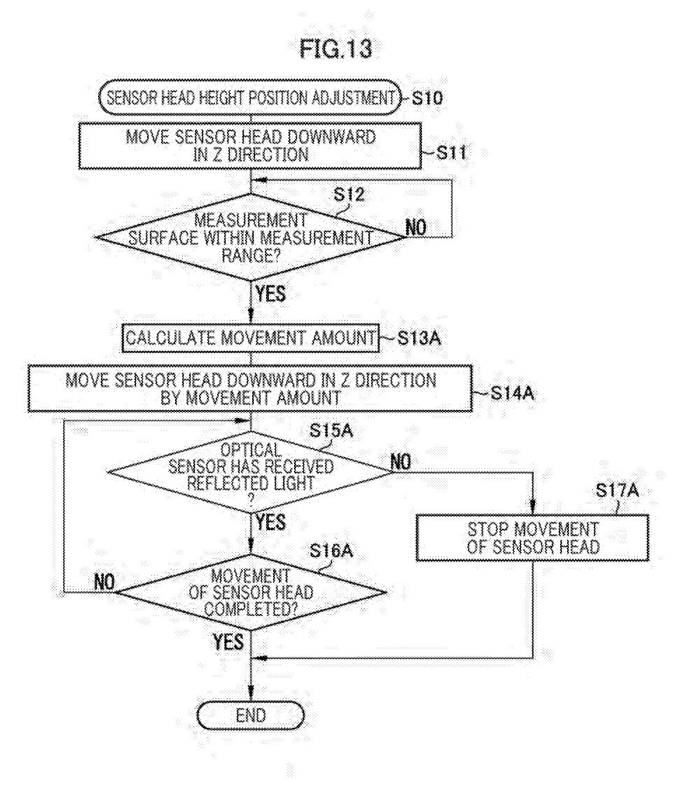

Referring back to FIG. 11, in a case where a starting operation height position adjustment on the sensor head 20 is executed at an operation unit 22, the height position adjusting unit 40 according to the second embodiment (corresponding to a position adjusting unit according to the present invention) drives a C-axis movement mechanism 16 based on a result of reception of reflected light LA by an optical sensor 36 and the movement amount Δh to automatically move the sensor head 20 to the target height position H1 (see FIG. 13 (to be described later)).

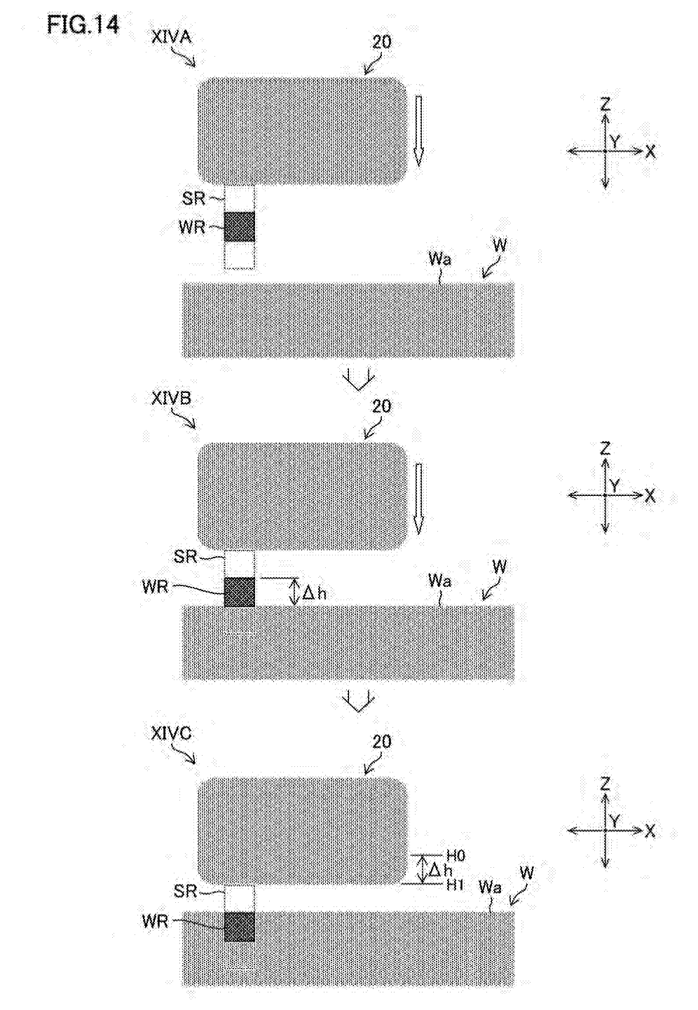

FIG. 13 is a flowchart showing the flow of a height position adjustment process on the sensor head 20 in the surface shape measuring apparatus 10 according to the second embodiment. FIG. 14 is an explanatory view for explaining the height position adjustment process on the sensor head 20 in the surface shape measuring apparatus 10 according to the second embodiment.

As shown in FIGS. 13 and 14, in response to a starting operation height position adjustment at the operation unit 22 by an operator, the height position adjusting unit 40 drives the C-axis movement mechanism 16 to move the sensor head 20 downward in a Z direction along a C-axis unit 14 at high speed (step S11, see reference character XIVA in FIG. 14). With this movement, the sensor head 20 approaches the measurement surface Wa at high speed. The height position adjusting unit 40 continues moving the sensor head 20 downward in the Z direction at high speed to a position at which the reflected light LA is received in a first light-receiving region E1, i.e., a position at which the measurement surface Wa reaches the lower end of the measurement range WR (NO in step S12).

When the sensor head 20 moves close enough to the measurement surface Wa that the sensor head 20 reaches a reference position H0 at which the measurement surface Wa reaches the lower end of the measurement range WR (YES in step S12, see reference character XIVB in FIG. 14), the reflected light LA is received in the first light-receiving region E1. In a case where the reflected light LA is received in the first light-receiving region E1, i.e., a case where the sensor head 20 reaches the reference position H0, the height position adjusting unit 40 acquires a result of computing the movement amount Δh from the movement amount calculation unit 41 (step S13A). Note that the timing for the height position adjusting unit 40 to acquire the movement amount Δh is not particularly limited as long as the timing is before step S14A (to be described later).

The height position adjusting unit 40 drives the C-axis movement mechanism 16 to further move the sensor head 20 downward in the Z direction from the reference position H0 by the movement amount Δh at high speed (low speed acceptable), i.e., move the sensor head 20 closer to the measurement surface Wa (step S14A).

During the downward movement of the sensor head 20 in the Z direction from the reference position H0 by the movement amount Δh, the height position adjusting unit 40 monitors whether the reflected light LA is received by the light-receiving surface 36a. In a case where the optical sensor 36 is no longer capable of receiving the reflected light LA during the movement of the sensor head 20, the height position adjusting unit 40 stops the movement of the sensor head 20 by the C-axis movement mechanism 16 (NO in step S15A, NO in step S16A, and step S17A).

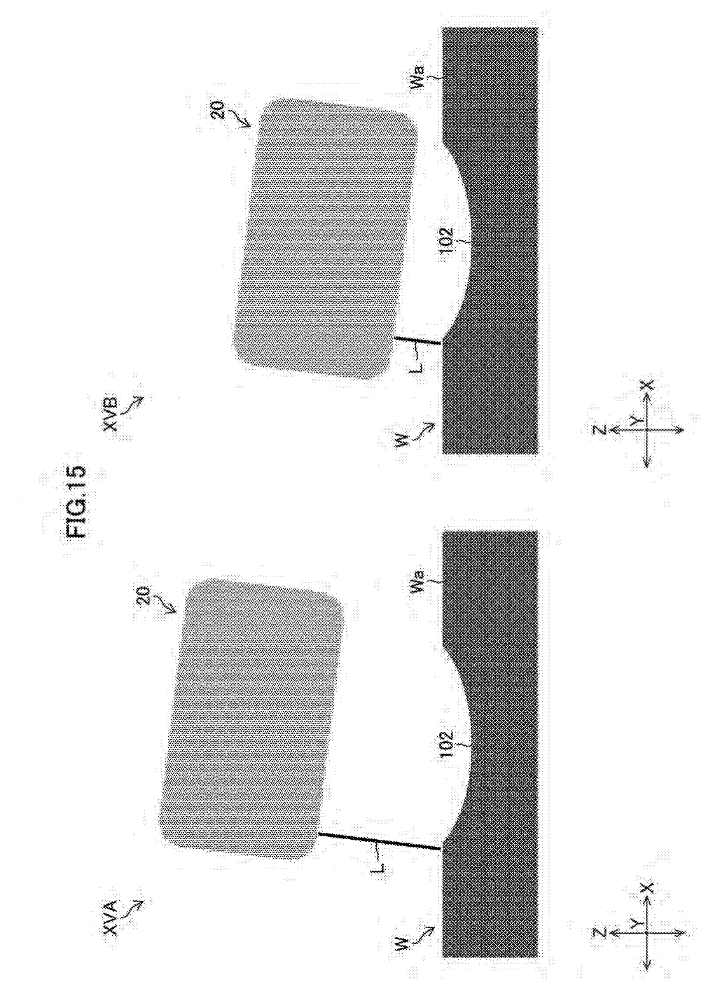

FIG. 15 is an explanatory view for explaining a reason to stop movement of the sensor head 20 in step S17A of FIG. 14. As indicated by reference characters XVA and XVB of FIG. 15, it is difficult to precisely align an emission direction (a measurement axis) of measurement light L from the sensor head 20 with the C-axis unit 14 (the Z direction), and the emission direction may be inclined with respect to the Z direction. In this case, an incidence position of the measurement light L incident from the sensor head 20 on the measurement surface Wa changes as the sensor head 20 moves downward in the Z direction. For this reason, in a case where the measurement surface Wa is inclined or the measurement surface Wa has projections or depressions (e.g., a recessed portion 102), the optical sensor 36 may fail to receive the reflected light LA and lose its sensitivity, during downward movement of the sensor head 20 in the Z direction (during approach to the measurement surface Wa). As a result, continuation of the downward movement of the sensor head 20 in the Z direction may bring the sensor head 20 into contact with the measurement surface Wa.

Under the circumstances, in the second embodiment, in a case where the optical sensor 36 loses sensitivity while the sensor head 20 is further moved downward in the Z direction from the reference position H0 by the movement amount Δh, the movement of the sensor head 20 is stopped. This makes it possible to prevent the sensor head 20 from coming into contact with the measurement surface Wa.

Note that, in a case where a proximity determination unit 42 determines, by proximity determination, that the sensor head 20 is in a "proximity state", i.e., a case where the sensor head 20 has moved close enough to the measurement surface Wa that the sensor head 20 reaches a position at which the measurement surface Wa falls within a proximity range SR, the height position adjusting unit 40 may stop movement of the sensor head 20.

Referring back to FIGS. 13 and 14, in a case where the height position adjusting unit 40 causes the C-axis movement mechanism 16 to move the sensor head 20 downward in the Z direction from the reference position H0 by the movement amount Δh, the height position adjusting unit 40 stops the movement of the sensor head 20 by the C-axis movement mechanism 16 (YES in step S15A and YES in step S16A). With this stop, the position of the sensor head 20 is automatically adjusted to the target height position H1 (see reference character XIVC in FIG. 14). Note that, since subsequent processes are the same as those in the first embodiment (see FIG. 8), a specific description thereof will be omitted.

As has been described above, the surface shape measuring apparatus 10 according to the second embodiment can automatically execute height position adjustment on the sensor head 20. It is thus possible to positionally adjust the sensor head 20 to the target height position H1 with greater ease and higher accuracy in a shorter time than in the first embodiment.

### Third Embodiment

The surface shape measuring apparatus 10 according to each of the above-described embodiments uses the sensor head 20 based on a triangulation method to measure a distance between the sensor head 20 and the measurement surface Wa. The present invention is also applicable to a surface shape measuring apparatus 10 that uses a sensor head 20 (not shown) based on a publicly known color confocal method to measure a distance to a measurement surface Wa. Note that components functionally or structurally identical to those in each of the embodiments are denoted by identical reference numerals, and a description thereof will be omitted.

In the sensor head 20 based on the color confocal method, a wavelength of reflected light LA incident on the sensor head 20 (a pinhole (not shown) (for, e.g., a fiber cable)) changes in accordance with a distance between the sensor head 20 and the measurement surface Wa, and an incidence position of the reflected light LA incident on a light-receiving surface 36a (a pixel position on the light-receiving surface 36a) changes in accordance with the wavelength of the reflected light LA. For this reason, like the above-described embodiments, the size of the light-receiving surface 36a is made larger in the sensor head 20 based on the color confocal method than existing ones. This allows detection of the measurement surface Wa within the proximity range SR. Note that measurement light L and the reflected light LA are coaxial in the sensor head 20 based on the color confocal method.

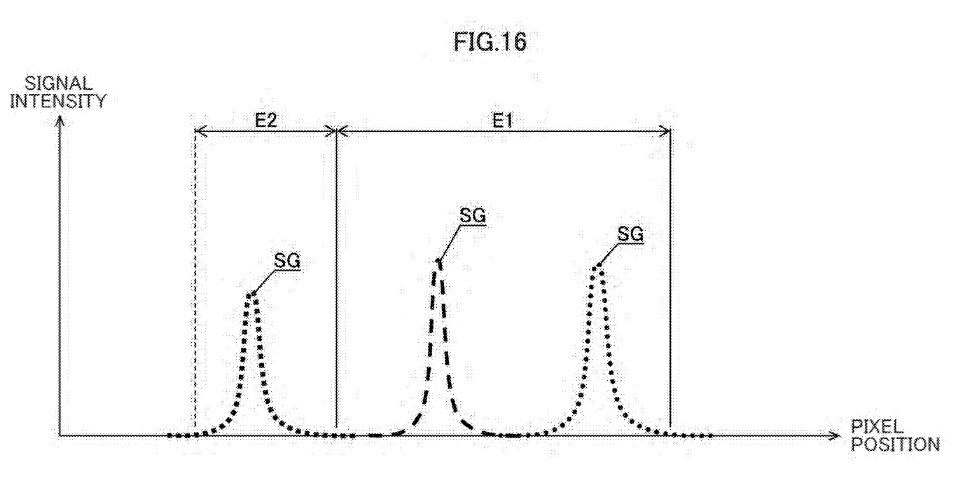

FIG. 16 is an explanatory chart for explaining a first light-receiving region E1 and a second light-receiving region E2 on the light-receiving surface 36a of an optical sensor 36 that receives the reflected light LA incident on the sensor head 20 based on the color confocal method. Note that the abscissa in FIG. 16 indicates a pixel position on the light-receiving surface 36a while the ordinate indicates a signal intensity of a light reception signal (denoted by reference character SG) of the reflected light LA received by the light-receiving surface 36a.

As shown in FIG. 16, the light-receiving surface 36a according to the third embodiment is sized to include the first light-receiving region E1 that receives the reflected light LA from the measurement surface Wa within a measurement range WR and the second light-receiving region E2 that receives the reflected light LA from the measurement surface Wa within the proximity range SR, as in the above-described embodiments. A part of the optical sensor 36 (the light-receiving surface 36a) is assigned for a proximity sensor, as in the embodiments, and the same effects as those of the embodiments can be obtained.

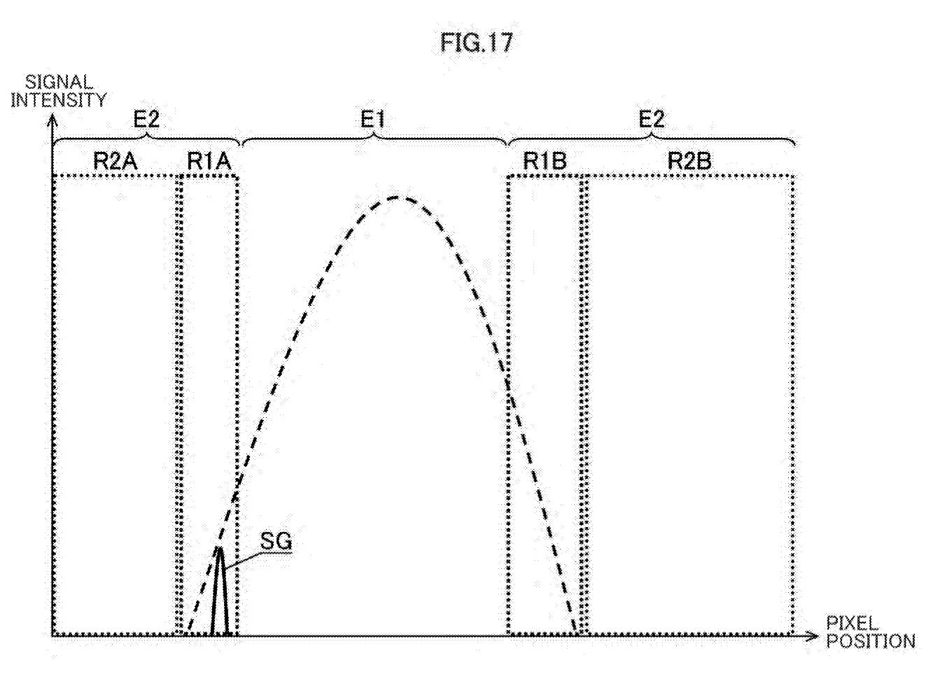

FIG. 17 is an explanatory chart for explaining, in detail, the second light-receiving region E2 described with reference to FIG. 16. As shown in FIG. 17, in a case where sensitivity (a signal intensity (voltage value) of a light reception signal of the reflected light LA) changes in accordance with on the incidence position of the reflected light LA incident on the light-receiving surface 36a (the pixel position on the light-receiving surface 36a), a distance between the sensor head 20 and the measurement surface Wa can be measured in accordance with the magnitude of the sensitivity. In this case, the sensitivity decreases gradually with increase in a distance of the incidence position of the reflected light LA on the light-receiving surface 36a from a middle pixel position.

Specifically, when the incidence position falls below a lower threshold range R1A where sensitivity is detectable, the range becomes a zero-sensitivity range R2A where the sensitivity is zero (including substantially zero). In addition, when the incidence position exceeds an upper threshold range R1B where sensitivity is detectable, the range becomes a zero-sensitivity range R2B where the sensitivity is zero. The lower threshold range R1A and the upper threshold range R1B have low sensitivities (low S/N ratios) and may be unsuitable for distance measurement. Particularly, the lower threshold range R1A and the upper threshold range R1B are unsuitable for distance measurement, in a case where a lens is selected such that the measurement light L has a small spot diameter in the first light-receiving region E1. For this reason, the lower threshold range R1A and the upper threshold range R1B can also be included in the second light-receiving region E2.

### Fourth Embodiment

A surface shape measuring apparatus 10 according to a fourth embodiment will be described. Although the proximity determination unit 42 executes proximity determination based on whether a proximity signal is output from the optical sensor 36 in the surface shape measuring apparatus 10 according to each of the above-described embodiments, an proximity determination unit 42 executes proximity determination based on a voltage value (signal intensity) of a light reception signal output from an optical sensor 36 in the surface shape measuring apparatus 10 according to the fourth embodiment.

Note that the surface shape measuring apparatus 10 according to the fourth embodiment has basically the same configuration as the surface shape measuring apparatuses 10 according to the embodiments except that the surface shape measuring apparatus 10 has a function of outputting a voltage value (signal value) of a light reception signal output from the optical sensor 36 to the proximity determination unit 42. For this reason, components functionally or structurally identical to those in the embodiments are denoted by identical reference numerals, and a description thereof will be omitted.

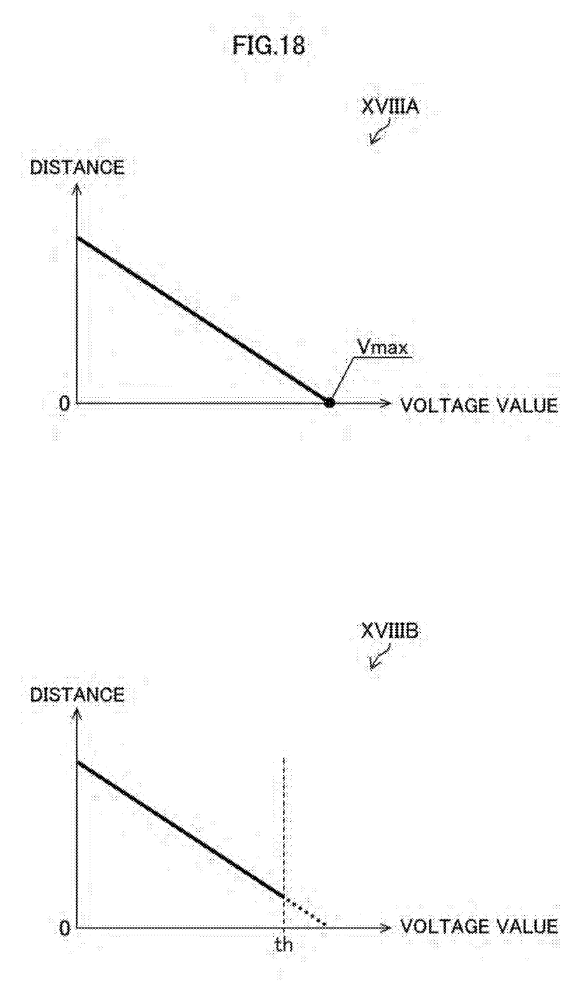

FIG. 18 is an explanatory chart for explaining a method for proximity determination by the proximity determination unit 42 according to the fourth embodiment. Note that a case where a voltage value of a light reception signal output from the optical sensor 36 increases as the sensor head 20 moves close to a measurement surface Wa to reduce a distance therebetween will be described here as an example.

As shown in FIG. 18, the proximity determination unit 42 according to the fourth embodiment performs proximity determination based on whether a voltage value of a light reception signal output from the optical sensor 36 has reached a predetermined maximum value Vmax (the voltage value = Vmax), as indicated by reference character XVIIIA, or whether the voltage value has reached a predetermined upper threshold Th (the voltage value = Th), as indicated by reference character XVIIIB. In other words, a light reception signal having the maximum value Vmax or the upper threshold Th is applied as a proximity signal.

Note that, in a case where a voltage value of a light reception signal output from the optical sensor 36 decreases with decrease in the distance between the sensor head 20 and the measurement surface Wa, the proximity determination unit 42 performs proximity determination based on whether a voltage value of a light reception signal output from the optical sensor 36 has reached a predetermined minimum value or a lower threshold (not shown). In other words, a light reception signal having the minimum value or the lower threshold is applied as a proximity signal.

### Modifications

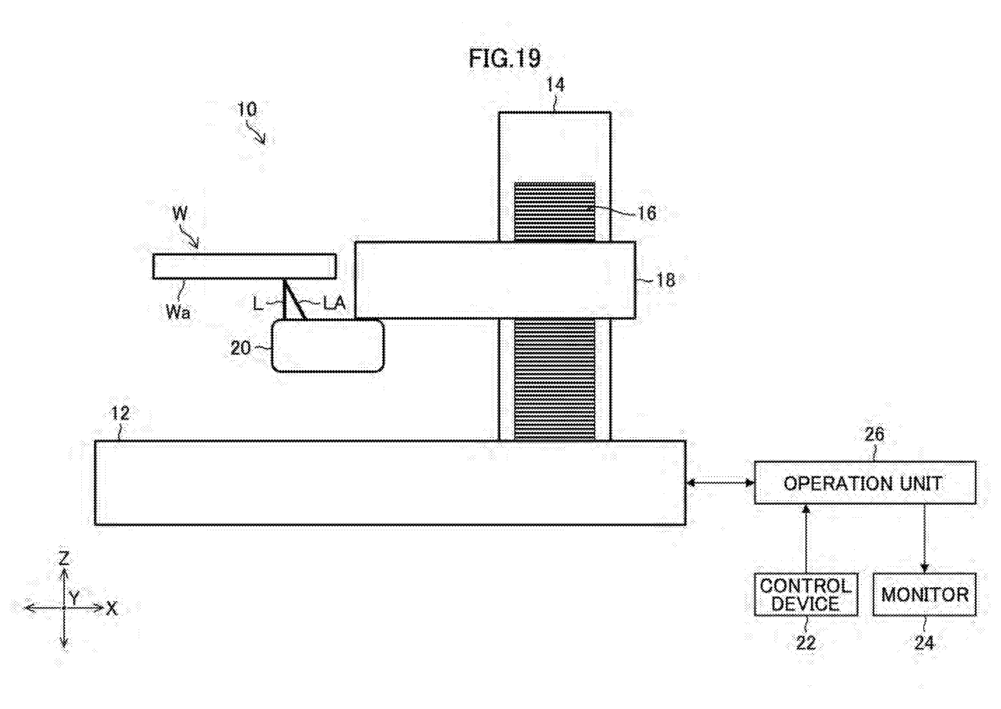

FIG. 19 is an explanatory view for explaining a modification of the surface shape measuring apparatuses 10 according to the above-described embodiments. In the surface shape measuring apparatus 10 according to each of the embodiments, the sensor head 20 comes near to the measurement surface Wa when the holder 18 is moved downward in the Z direction by the C-axis movement mechanism 16 and separates from the measurement surface Wa when the holder 18 is moved upward in the Z direction by the C-axis movement mechanism 16. The present invention, however, is not limited to this. For example, as shown in FIG. 19, the surface shape measuring apparatus 10 may be configured such that the sensor head 20 separates from the measurement surface Wa when the holder 18 is moved downward in the Z direction by the C-axis movement mechanism 16, and the sensor head 20 approaches to the measurement surface Wa when the holder 18 is moved upward in the Z direction by the C-axis movement mechanism 16.

### Others

Although the light source 30 and the optical sensor 36 are provided in the sensor head 20 in each of the above-described embodiments, the light source 30 and/or the optical sensor 36 may be provided outside the sensor head 20. In this case, an optical system that guides the measurement light L from the light source 30 to the sensor head 20 is separately provided or an optical system that guides the reflected light LA incident on the sensor head 20 to the optical sensor 36 is separately provided.

Although the C-axis unit 14 corresponding to the movement axis according to the present invention is parallel to the Z direction (vertical direction) in the embodiments, the C-axis unit 14 may be parallel to an arbitrary direction other than the Z direction.

Although the sensor head 20 is moved in the Z direction along the C-axis unit 14 by the C-axis movement mechanism 16 in the embodiments, the workpiece W may be moved along the movement axis by arbitrary type of movement mechanism that is publicly known, instead of moving the sensor head 20.

Although the triangulation method and the color confocal method have been described as examples of a method for measuring a distance from the sensor head 20 to the measurement surface Wa in the embodiments, the present invention can be applied to an arbitrary type of distance measurement method capable of distance measurement in accordance with an incidence position of the reflected light LA on the light-receiving surface 36a.

Although the surface shape measuring apparatuses 10 have been described as examples in the embodiments, the present invention can be applied to arbitrary type of shape measuring apparatus that measures arbitrary type of shape of the measurement surface Wa in a non-contact manner.

### Reference Signs List

10: surface shape measuring apparatus, 12: measurement table, 14: C-axis unit, 16: C-axis movement mechanism, 18: holder, 18a: X-axis movement mechanism, 18b: X-position sensor, 20: sensor head, 22: operation unit, 22a: elevating lever, 24: monitor, 26: control device, 30: light source, 32: light entrance/exit surface, 32a: light exit window, 32b: light entrance window, 34: lens, 36: optical sensor, 36a: light-receiving surface, 40: height position adjusting unit, 41: movement amount calculation unit, 42: proximity determination unit, 43: adjustment end determination unit, 44: shape measurement control unit, 46: distance measurement unit, 48: shape calculation unit, 100: sensor head, 102: recessed portion, E1: first light-receiving region, E2: second light-receiving region, H0: reference position, H1: target height position, L: measurement light, LA: reflected light, MR: head position range, R1A: lower threshold range, R1B: upper threshold range, R2A: zero-sensitivity range, R2B: zero-sensitivity range, SR: proximity range, Th: upper threshold, Vmax: maximum value, W: workpiece, WR: measurement range, Wa: measurement surface, Δh: movement amount

What is claimed is:

1. A non-contact shape measuring apparatus comprising:
a sensor head configured to emit measurement light toward a measurement surface and receive incident reflected light of the measurement light reflected by the measurement surface;
an optical sensor having a light-receiving surface that receives the reflected light incident on the sensor head, in which an incidence position of the reflected light on the light-receiving surface changes in accordance with a distance between the sensor head and the measurement surface;
a distance measurement unit configured to measure the distance based on the incidence position of the reflected light on the light-receiving surface; and
a movement mechanism configured to move one of the sensor head and the measurement surface toward and away from the other of the sensor head and the measurement surface, along a movement axis determined in advance,
wherein a measurement range for measuring the distance in the emission direction, is set in advance at a position separated from the sensor head in an emission direction of the measurement light, and
the light-receiving surface has a size sufficient to receive the reflected light even in a case where the movement mechanism moves the one toward the other until the one reaches a position at which the measurement surface falls within a proximity range that is a range set between the sensor head and the measurement range.

2. The non-contact shape measuring apparatus according to claim 1, wherein the reflected light that is reflected by the measurement surface to a direction different from an incident direction of the measurement light comes incident on the sensor head.

3. The non-contact shape measuring apparatus according to claim 1, wherein the measurement light emitted from the sensor head and the reflected light incident on the sensor head are coaxial.

4. The non-contact shape measuring apparatus according to claim 1, comprising:
a position adjusting unit configured to drive the movement mechanism to move the one toward the other; and
a movement amount calculation unit configured to calculate a movement amount required to make the other closest to the one within a range where the measurement surface falls within the measurement range, after the measurement surface reaches the measurement range during approach of the one toward the other, wherein
the position adjusting unit drives the movement mechanism to move the one toward the other by the movement amount, after the measurement surface reaches the measurement range during approach of the one to the other, based on a result of reception of the reflected light by the optical sensor.

5. The non-contact shape measuring apparatus according to claim 4, wherein the position adjusting unit stops the driving of the movement mechanism in a case where the optical sensor fails to receive the reflected light, after the measurement surface reaches the measurement range.

6. The non-contact shape measuring apparatus according to claim 1, comprising
a proximity determination unit configured to determine whether the one has moved toward the other until the one reaches a position at which the measurement surface falls within the proximity range, based on a voltage value of a light reception signal of the reflected light output from the optical sensor,
wherein the voltage value of the light reception signal varies in accordance with the incidence position of the reflected light on the light-receiving surface.

7. The non-contact shape measuring apparatus according to claim 1, wherein the movement axis is parallel to a vertical direction.

8. A position adjustment method for adjusting a position of the one along the movement axis in the non-contact shape measuring apparatus according to claim 1, the method comprising:
a first approach step of moving, by the movement mechanism, the one toward the other;
a first stop step of stopping the first approach step at a position at which the measurement surface falls within the measurement range, based on a result of reception of the reflected light by the optical sensor during execution of the first approach step;
a second approach step of moving, by the movement mechanism, the one toward the other after the first stop step;
a signal output step of outputting a proximity signal indicating that the one is in a proximity of the other in a case where the one is moved toward the other until the one reaches a position at which the measurement surface falls within the proximity range, based on a result of reception of the reflected light by the optical sensor during execution of the second approach step;
a separation step of moving, by the movement mechanism, the one away from the other in a case where the signal output step is executed; and
a second stop step of stopping the separation step in a case where the measurement surface reaches the measurement range, based on a result of reception of the reflected light by the optical sensor during execution of the separation step.

9. The position adjustment method according to claim 8, wherein the one is moved at higher speed in the first approach step than in the second approach step and the separation step.
